(19) United States
(12) Patent Application Publication
(10) Pub. No.: US 2021/0273948 A1
(43) Pub. Date: Sep. 2, 2021

(54) COMPUTER-IMPLEMENTED SYSTEM AND METHODS FOR CONTROLLING DATA STORAGE AND SOFTWARE ACCESS IN A MULTI-DEVICE COMPUTING NETWORK

(71) Applicant: Castalune LLC, Reading, MA (US)

(72) Inventor: Robert Miller, Reading, MA (US)

(73) Assignee: Castalune LLC, Reading, MA (US)

(21) Appl. No.: 17/183,839

(22) Filed: Feb. 24, 2021

Related U.S. Application Data
(60) Provisional application No. 62/982,205, filed on Feb. 27, 2020.

(51) Int. Cl. H04L 29/06

(52) U.S. Cl. CPC H04L 63/107; G06F 8/61; H04L 67/42

(57) ABSTRACT

A system for controlling data storage and software access in a multi-device computing network enables the storage, and more preferably the temporary storage of local dataset data and system modules on one or more client devices, such as data owner client devices and/or surrogate client devices, which can then only be accessed based on specific thresholds or characteristics which may be input, defined, selected, by a data owner. The system allows known and permissioned client users that meet such thresholds and characteristics to access, process and decrypt various encrypted data that has been stored, in whole or in part, across one or more owner client devices and/or surrogate client devices, while the system modules required to process the data of a local data set are moved to the secure location(s) by being stored on one or more owner client devices and/or surrogate client devices.

### CROSS REFERENCE TO RELATED APPLICATIONS

This application claims priority to and the benefit of the filing date of U.S. Provisional Application No. 62/982,205, filed on Feb. 27, 2020, entitled “A SYSTEM AND METHOD FOR DATA STORAGE AND SECURITY IN A MULTI-DEVICE COMPUTING NETWORK”, which is hereby incorporated by reference in its entirety.

### FIELD OF THE INVENTION

This patent specification relates to the field of systems and methods of controlling data and software access by computing devices in a multi-device computing network, more particularly to a system and methods for enabling data and software to be installed onto and removed from computing devices in a multi-device computing network and for controlling the output of the software.

### BACKGROUND

With current public cloud providers, data is stored in centralized locations (e.g., datacenters) and the access to said data is centrally permissioned for specific parties. When using cloud computing services, organizations currently store data in defined physical locations, with limited ability to direct which specific pieces of data are stored and shared, between different devices based on other characteristics. It is a valuable security capability to control the movement of, access to, and use of data based on additional characteristics beyond physical location. This is particularly true in a multi-cloud environment, where organizations have access to a wider variety of device types (ex. smartphones, tablets, laptops) and providers (ex. public cloud providers, onsite equipment).

As the volume of data continues to grow it is increasingly important to have data stored and accessed at the ‘edge’ of networks due to the slower performance of centralized frameworks. This is reflected in current commercial agreements, and security protocols, that levy costs for moving data out of central locations to the edge, and back. Edge nodes are specialized and do not support broader use cases (e.g., smartphones not designed to support pattern recognition analysis). As edge nodes become more powerful and are used for autonomous data collection and analysis, there will be more sensitive information stored outside of centralized cloud facilities.

The movement of data between locations, which have varying levels of security, to be processed exposes the owner of data to security issues such as theft, corruption, and cloning, among others. As organizations generate and collect larger volumes of sensitive data, there exists an ever-present need for novel systems and methods for securing data in networks. A further need exists for novel computer-implemented systems and methods which are able to provide a scalable system for computing devices to identify, encrypt, store, permission and compute data based on a range of user-defined characteristics.

### BRIEF SUMMARY OF THE INVENTION

A system and methods for controlling data storage and software access in a multi-device computing network are provided. In some embodiments, the system enables data owners to maintain control over the data of one or more of their local datasets within a cloud computing environment. The system may enable and govern the storage of, and access to, data of one or more local datasets in a distributed network of client devices based on the relationship of one client device to another, the type of data in question, and the performance of the network and system modules used for processing of the data of the local datasets. The relationship of the client devices may include, but is not limited to, the physical location of client device, the user of the client devices, the data being exchanged, and the internet network the client devices use.

In further embodiments, the system enables the storage, and more preferably the temporary storage of local dataset data and system modules (software modules) on one or more owner client devices and/or surrogate client devices which can then only be accessed based on specific thresholds or characteristics which may be input, defined, selected, by a data owner. The system may require the data owner of a local dataset to allow access to, and decryption of, the data prior to an authorized requesting user or unknown requesting user gaining ability to access, decrypt, process, or store data. The system allows known and permissioned parties that meet such thresholds and characteristics, e.g., authorized requesting users, client users, to access, process and decrypt various encrypted data that has been stored, in whole or in part, across one or more owner client devices and/or surrogate client devices. In this manner, the system allows data of a local data set to remain in secure location(s) by being stored on one or more owner client devices and/or surrogate client devices, while the system modules required to process the data of a local data set are moved to the secure location(s) by being stored on one or more owner client devices and/or surrogate client devices. This contrasts with existing systems and methods which move the data of datasets between different locations or computing devices, of varying degrees of security, to be processed.

According to one embodiment consistent with the principles of the invention, a computer implemented method for method for installing, authorizing, and running approved software modules in a network that includes at least one client device, the network having a local dataset controlled by an owner of the local dataset is provided. Client devices may include owner client devices and/or surrogate client devices. In some embodiments, the method may include the steps of: sending a data processing request for a local dataset from a requesting user, via a requesting device, to a data owner device; determining one or more client devices capable of performing the data processing request; receiving approval for the performance of the data processing request from the first data owner device; providing access to a system module for the one or more client devices capable of performing the data processing request; generating, via the one or more client devices, a data processing output; providing the data processing output to the requesting device; and revoking the ability of one or more of the client devices to access the system module.

According to another embodiment consistent with the principles of the invention, a computer implemented method for controlling the distributing and storing of data of a local dataset of a data owner on one or more client devices is provided. In some embodiments, the method may include the steps of: generating a list of one or more client users, the list including at least a first client user and a second client user with each client user having one or more client devices; receiving authorization from one or more client users, such as the first client user and second client user, to store data of the local dataset on one or more of their respective client devices; providing security proximity data to a data owner device of the data owner, the security proximity data describing how secure the one or more client devices, such as the first client device and second client device, are in relation to the data owner; receiving device selection data from the data owner, via the data owner device, the selection data enabling one or more client devices, such as the first client device and second client device, to receive and store one or more partial local datasets, such as a first partial local dataset and a second partial local dataset, in which the first partial local dataset contains a first portion of the data of the local data and the second partial local dataset contains a second portion of the data of the local data; providing the first partial local dataset to the first client device and the second partial local dataset to the second client device; receiving revocation data from the data owner, via the data owner device, the revocation data revoking access of at least one of the first client device to the first partial local dataset and the second client device to the second partial local dataset; and removing at least one of the first partial local dataset from the first client device and the second partial local dataset from the second client device.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts an illustrative example of some of the components and computer implemented methods which may be found in a system for controlling data storage and software access in a multi-device computing network according to various embodiments described herein.

FIG. 2—FIG. 2 illustrates a block diagram showing an example of a server which may be used by the system as described in various embodiments herein.

FIG. 3—FIG. 3 shows a block diagram illustrating an example of a client device which may be used by the system as described in various embodiments herein.

FIG. 4—FIG. 4 depicts a block diagram illustrating some applications of a system for controlling data storage and software access in a multi-device computing network which may function as software rules engines according to various embodiments described herein.

FIG. 5—FIG. 5 illustrates a schematic diagram of some example functions of an association module which may enable an unknown requesting device and an unknown requesting user to become an authorized requesting device and authorized requesting user according to various embodiments described herein.

FIG. 6—FIG. 6 shows a schematic diagram of some example functions of an association module which may enable an authorized requesting device and authorized requesting user to become a client device and client user according to various embodiments described herein.

FIG. 7—FIG. 7 depicts a schematic diagram of an example embodiment of how the system may enable accessing various encrypted data stored in a distributed network of client devices according to various embodiments described herein.

FIG. 8A—FIG. 8A illustrates a schematic diagram of an example embodiment of how the system, via one or more computing devices may enable a known entity or authorized requesting user to request data via a data processing request from their authorized requesting device in a distributed network of devices, in which a system module for processing the data processing request is identified in a module catalogue of approved system modules according to various embodiments described herein.

FIG. 8B—FIG. 8B depicts a schematic diagram of an example embodiment of how the system may provide a system module, such as identified in FIG. 8A, to a computing device, such as a server, client device(s), etc., to generate a data processing output in response to the data processing request according to various embodiments described herein.

FIG. 9—FIG. 9 shows a block diagram of an example of a computer-implemented method for installing, authorizing, and running approved software modules in a network that includes at least one client device, the network having a local dataset controlled by an owner of the local dataset according to various embodiments described herein.

FIG. 10—FIG. 10 depicts a block diagram of an example of a computer-implemented method for controlling the distributing and storing of data of a local dataset of a data owner on one or more client devices according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented systems and methods for controlling data storage and software access in a multi-device computing network are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

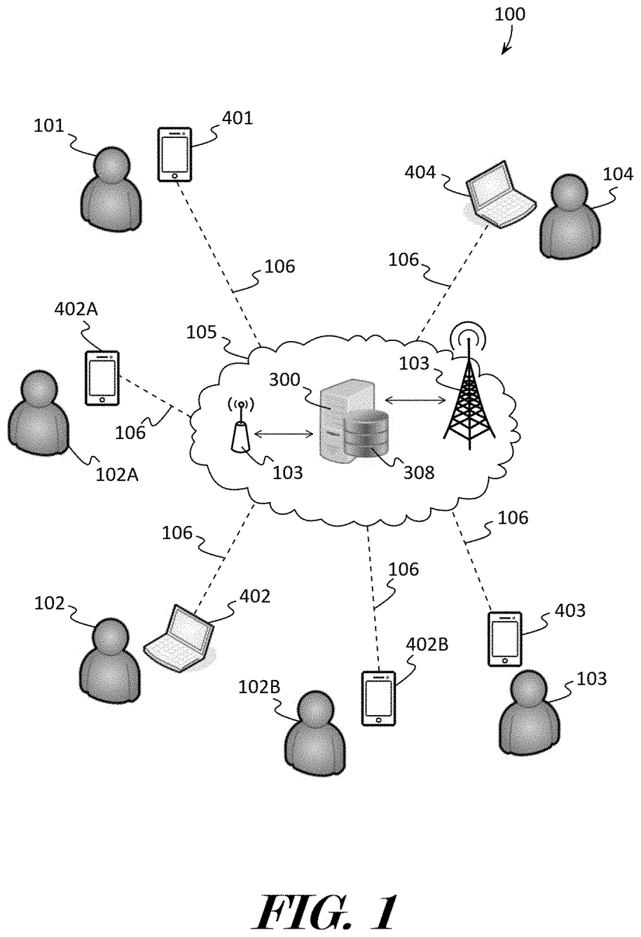

The present invention will now be described by example and through referencing the appended figures representing preferred and alternative embodiments. As perhaps best shown by FIG. 1, an illustrative example of some of the physical components which may comprise a system for controlling data storage and software access in a multi-device computing network (“the system”) 100 according to some embodiments is presented. The system 100 is configured to facilitate the transfer of data and software (sometimes called “system modules 150”) between one or more access points 103, computing devices 401, 402, 403, 404, and servers 300 over a data network 105. Each computing device 401, 402, 403, 404, may send data to and receive data, the data, the data optionally comprising a system module 150, from the data network 105 through a network connection 106 with an access point 103. A data store 308 accessible by the server 300 may contain one or more databases having one or more local datasets 120. The data of a local dataset 120 may comprise any information that the owner of the local dataset 120 (the data owner 101) may desire to limit and/or prevent access to.

In this example, the system 100 comprises a number of computing devices, which may include at least one of: a data owner device 401; a client device 402; an authorized requesting device 403; and/or an unknown requesting device 404 (but preferably more than two of the devices 401, 402, 403, 404). Computing devices 401, 402, 403, 404, can be: personal computers, workstations, servers, mobile devices, such as laptops, tablet computers, personal digital assistants, smart phones, and the like, that are equipped with a wireless network interface capable of sending data to one or more servers 300, which may be a type of network computing device, with access to one or more data stores 308 over a network 105, such as a wireless local area network (WLAN). Additionally, computing devices 401, 402, 403, 404, can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one computing device 401, 402, 403, 404, and/or server 300 programmed to perform one or more of the steps described herein. In preferred embodiments, more than one computing device 401, 402, 403, 404, and/or server 300 may be used, with each being programmed to carry out one or more steps of a method or process described herein.

In some embodiments, the system 100 may be configured to facilitate the communication of information to and from one or more users 101, 102, 103, 104, through their respective computing devices 401, 402, 403, 404, and servers 300 of the system 100.

A data owner device 401 may be owned and operated by a data owner 101, and the data owner 101 may use their data owner device 401 to interact with the system 100 to control access to a local dataset 120 that is also owned by the data owner 101. Generally, a local dataset 120 may comprise any data that the data owner 101 desires to limit and prevent access to by one or more individuals, companies, entities, etc. For example, data of a local dataset 120 may comprise manufacturing site energy meter data for a company which the data owner 101 desires to limit and prevent access to.

A client device 402 may be operated by a client user 102. Generally, a client device 402 may comprise a computing device that has or has been authorized by the data owner 101 to store all or portions of the data of a local dataset 120 and/or store and operate one or more system module(s) 150 which may perform a software operation on all or portions of the data of a local dataset 120. Optionally, a client device 402 may be owner client device 402A which may be owned by the data owner 101. As an example, a company may own a number of computing devices which may include smart phones, laptops, tablets, etc., and which may be configured as a data owner device 401 and owner client devices 402A. A company manager, functioning as a data owner 101, may operate a first data owner device 401 of the company, while a number of employees, functioning as owner users 102A, may operate the number of owner client devices 402A of the company. In this manner, the data owner 101 may own the data owner device 401 and owner client devices 402A and the owner users 102A may have temporary possession of the owner client devices 402A that they have been assigned. Optionally, a client device 402 may be owned by the surrogate user 102B of that surrogate client device 402B. For example, an employee or other individual (surrogate user 102B) may purchase and therefore have ownership of their smartphone type computing device which may be enrolled in the system 100 as a surrogate client device 402B.

An authorized requesting device 403 may be operated by an authorized requesting user 103 which may comprise an individual, company, entity, etc., which may be authorized by the data owner 101 to have access to all or portions of the data of a local dataset 120 and/or access to a data processing output 112 which may be generated by system module(s) 150 upon performing a software operation on all or portions of the data of a local dataset 120. Continuing the above example in which the data of a local dataset 120 comprises manufacturing site energy meter data for a company, an authorized requesting user 103 may comprise an electric utility company which needs to calculate an energy bill for the company based on the energy meter data. The data owner 101 may prevent the authorized requesting user 103 from accessing the data of a local dataset 120, but may enable the system 100 to provide a data processing output 112 which may be generated by system module(s) 150 upon performing a software operation on all or portions of the data of a local dataset 120 to the authorized requesting user 103 in which the data processing output 112 enables the electric utility company to calculate an energy bill.

An unknown requesting device 404 may be operated by an unknown requesting user 104 which may comprise an individual, company, entity, etc., which is not an authorized requesting user 103 but desires to become an authorized requesting user 103. An unknown requesting device 404 operated by an unknown requesting user 104 may be prevented by the system 100 from having access to all or portions of the data of a local dataset 120 and/or access to a data processing output 112 which may be generated by system module(s) 150 upon performing a software operation on all or portions of the data of a local dataset 120.

In preferred embodiments, the system 100 enables data owners 101 to maintain control of the data of one or more of their local datasets 120 within a cloud computing environment. The system 100 may enable and govern the storage of, and access to, data of one or more local datasets 120 in a distributed network 105 of computing devices 401, 402, 403, 404, based on the relationship of one computing device 401, 402, 403, 404, to another, the type of data in question, and the performance of the network 105 and the system modules 150 used for processing of the data of the local datasets 120. The relationship of the computing devices 401, 402, 403, 404, may include, but is not limited to, the physical location of computing device 401, 402, 403, 404, the user 101, 102, 103, 104, of the computing devices 401, 402, 403, 404, the data being exchanged, and the internet network 105 the computing devices 401, 402, 403, 404, use.

Generally, the system 100 enables the storage, and more preferably the temporary storage of local dataset 120 data and system modules 150 (software modules) on one or more client devices 402, such as owner client device(s) 402A and/or surrogate client device(s) 402B which can then only be accessed based on specific thresholds or characteristics which may be input, defined, selected, by a data owner 101 via their data owner device 401. Client device 402 access may be allowed by proximity score thresholds. Characteristics that make up the score may include geographic proximity between data owner devices 401 and/or client devices 402, network proximity between data owner devices 401 and/or client devices 402, and relationship between data owner 101 and client user 102. Characteristics that may be assigned or associated with the data of a local dataset 120 may include levels of confidentiality, e.g., low, medium, high, etc., and may also describe by the type of data of a local dataset 120. For example, business data, legal data, accounting data, HR data, marketing data, etc, and in case of an individual, financial data, photo and video data, schedule data, etc. The system 100 may require the data owner 101 of a local dataset 120 to allow access to, and decryption of, the data prior to an authorized requesting user 102 or unknown requesting user 103 gaining ability to access, decrypt, process, or store data. The system 100 allows known and permissioned parties that meet such thresholds and characteristics, e.g., authorized requesting users 103, client users 102, to access, process and decrypt various encrypted data that has been stored, in whole or in part, across one or more data owner devices 401 and/or client devices 402. In this manner, the system 100 allows data of a local data set 120 to remain in secure location(s) by being stored on one or more data owner devices 401 and/or client devices 402, while the system modules 150 required to process the data of a local data set 120 are moved to the secure location(s) by being stored on one or more data owner devices 401 and/or client devices 402. This contrasts with existing systems and methods which move the data of datasets between different locations or computing devices, of varying degrees of security, to be processed.

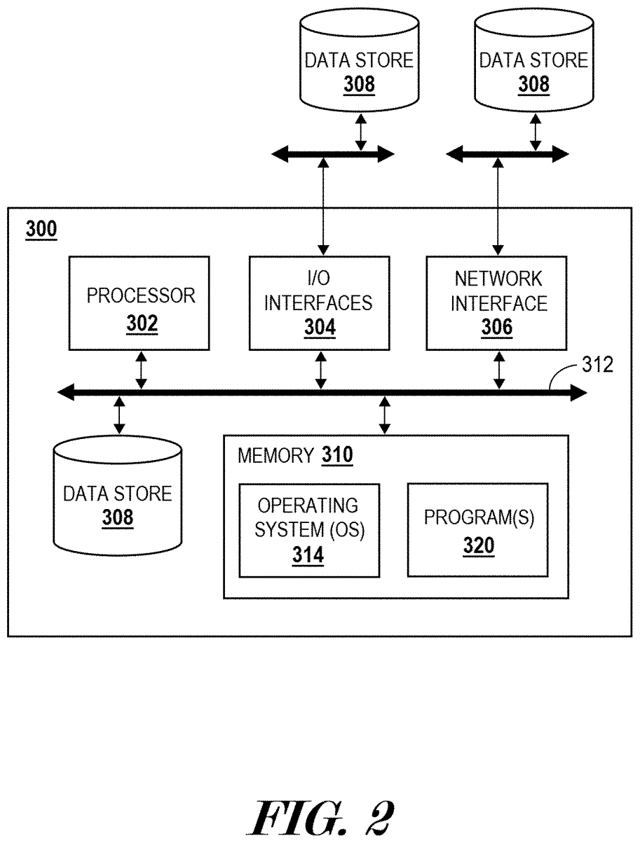

Referring now to FIG. 2, in an exemplary embodiment, a block diagram illustrates a server 300 of which one or more may be used in the system 100 or standalone and which may be a type of computing platform or computing device. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like.

The one or more programs 320, may be configured to implement the various processes, algorithms, methods, techniques, etc. described herein.

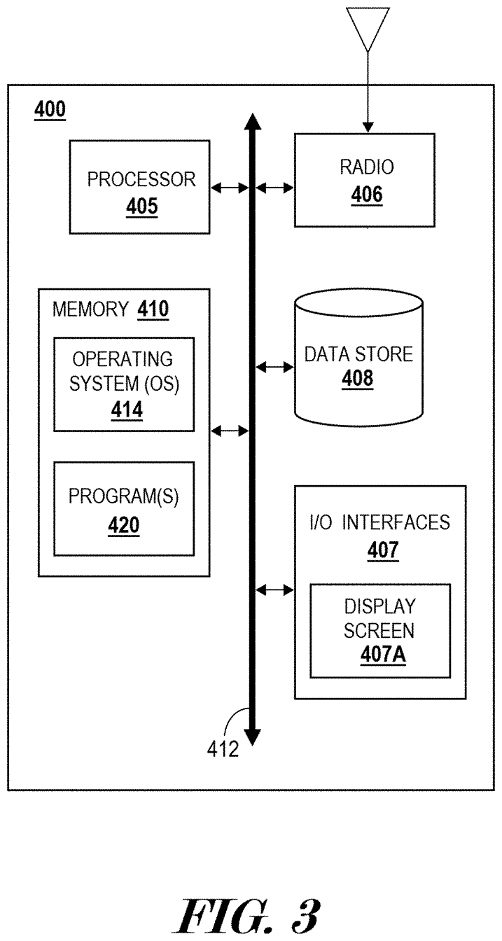

Referring to FIG. 3, in an exemplary embodiment, a block diagram illustrates a computing device 401, 402, 403, 404, of which one or more may be used in the system 100 or the like and which may be a type of computing platform or computing device. A computing device 401, 402, 403, 404, can be a digital device that, in terms of hardware architecture, generally includes a processor 405, radio 406, input/output (I/O) interfaces 407, data store 408, and memory 410. It should be appreciated by those of ordinary skill in the art that FIG. 3 depicts a computing device 401, 402, 403, 404, in an oversimplified manner, and a practical embodiment may include additional components and suitably configured processing logic to support known or conventional operating features that are not described in detail herein. The components (405, 406, 407, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 405 is a hardware device for executing software instructions. The processor 405 can be any custom made or commercially available processor, a central processing unit (CPU), an auxiliary processor among several processors associated with the computing device 401, 402, 403, 404, a semiconductor-based microprocessor (in the form of a microchip or chip set), or generally any device for executing software instructions. When the computing device 401, 402, 403, 404, is in operation, the processor 405 is configured to execute software stored within the memory 410, to communicate data to and from the memory 410, and to generally control operations of the computing device 401, 402, 403, 404, pursuant to the software instructions. In an exemplary embodiment, the processor 405 may include a mobile optimized processor such as optimized for power consumption and mobile applications.

The I/O interfaces 407 can be used to receive data and user input and/or for providing system output. User input can be provided via a plurality of I/O interfaces 407, such as a keypad, a touch screen, a camera, a microphone, a scroll ball, a scroll bar, buttons, bar code scanner, voice recognition, eye gesture, and the like. System output can be provided via a display screen 407A, such as a liquid crystal display (LCD), light emitting diode (LED) display, touch screen display, and the like. The I/O interfaces 407 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 407 can include a graphical user interface (GUI) that enables a user to interact with the computing device 401, 402, 403, 404. Additionally, the I/O interfaces 407 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 405. The software in memory 410 can include one or more software programs 420, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The programs 420 may include various applications, add-ons, etc. configured to provide end user functionality with the computing device 401, 402, 403, 404. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

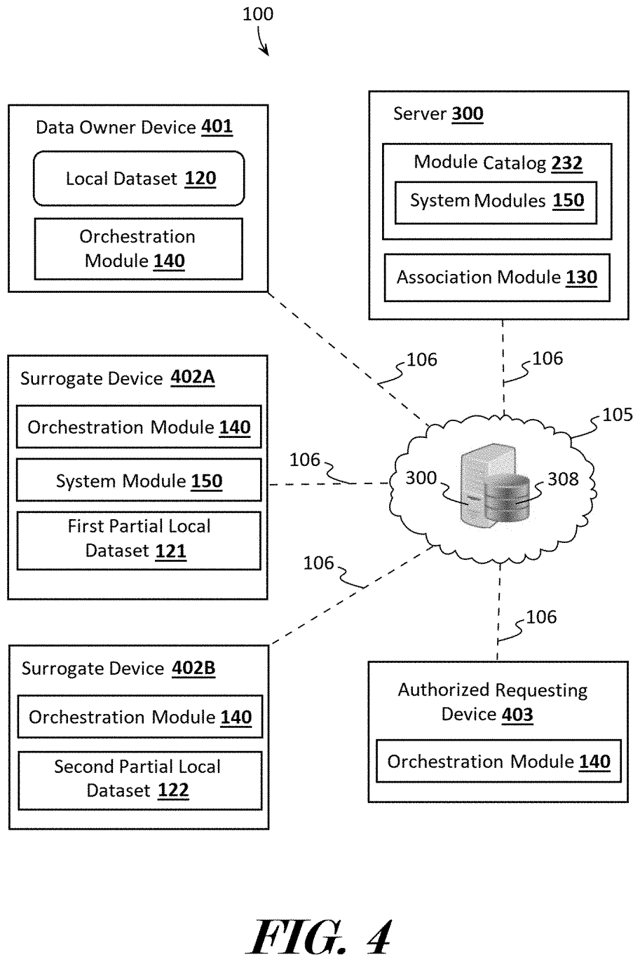

Referring now to FIGS. 4-8B, some software rules modules, engines, and components which may be found in a system 100 and which may optionally be configured to run on one or more servers 300, data owner devices 401, client devices 402, authorized requesting devices 403, and/or unknown requesting device 404 according to various embodiments described herein are illustrated. A server 300 and computing devices 401, 402, 403, 404, may be in wired and/or wireless electronic communication through a network 105 with a data store 308. The modules 130, 140, 150, may be in electronic communication so that data may be readily exchanged between the modules 130, 140, 150, and one or more modules 130, 140, 150, may read, write, or otherwise access data in one or more databases of one or more data stores 308.

In this and some embodiments, one or more servers 300 may be configured to run one or more software rules engines or programs, such as an association module 130, while client devices 401, 402, 403, 404, may be configured to run one or more software rules engines or programs, such as an orchestration module 140 and system modules 150. In other embodiments, an association module 130, orchestration module 140, and/or system module 150 may be configured to run on one or more computing devices 401, 402, 403, 404, and/or servers 300 with data transferred to and from a module 130, orchestration module 140, and/or system module 150 that may be in communication with a data store 308 through a network 105. It should be understood that the functions attributed to the modules 130, 140, 150, described herein are exemplary in nature, and that in alternative embodiments, any function attributed to any modules 130, 140, 150, may be performed by one or more other modules 130, 140, 150, or any other suitable processor logic.

The system 100 may comprise one or more local datasets 120 which may be stored on a data store 308, 408, accessible to one or more modules 130, 140, 150. In some embodiments, an entire local dataset 120 may be stored on a data owner device 401 and/or client device 402. In preferred embodiments, one or more portions of a local dataset 120 may be stored on one or more client devices 402 as partial local datasets 121, 122, 123, 124, 125, 126, etc. This provides data security in the case of a client device 402 being compromised because only a part of the local dataset 120 may have been distributed to that client device 402.

The system 100 may comprise one or more association modules 130. An association module 130 may comprise or function as association logic stored in a memory 310, 410, which may be executable by the processor 302, 405, of a server 300 and/or client device 402. In some embodiments, and in addition to any other functions described herein, an association module 130 may be configured to perform functions, such as registering computing devices 401, 402, 403, 404, categorizing computing devices 401, 402, 403, 404, dividing a local dataset 120 into one or more partial local datasets 121, 122, 123, 124, 125, 126, distributing one or more partial local datasets, 121, 122, 123, 124, 125, 126, to one or more client devices 402, sending orchestration modules 140 to one or more client devices 402, performing encryption/decryption on local datasets 120 and partial local datasets 121, 122, 123, 124, 125, 126, and communicating permissions to orchestration modules 140. In some embodiments, an association module 130 may include one or more software engines such as a decryptor engine 131, key manager engine 132, external execution module data transfer monitor engine 133, data manager engine 134, and module bus 135.

The system 100 may comprise one or more orchestration modules 140. An orchestration module 140 may comprise or function as orchestration logic stored in a memory 310, 410, which may be executable by the processor 302, 405, of a server 300 and/or computing device 401, 402, 403, 404. In some embodiments, and in addition to any other functions described herein, an orchestration module 140 may be configured to operate an I/O interface 404, such as a display screen 407A (optionally of a touchscreen interface), of a computing device 401, 402, 403, 404, operated by a user 101, 102, 103, 104, in order to provide and receive information from the system 100. In further embodiments, an orchestration module 140 may be configured to store and control access to a local dataset 120 and/or partial local dataset(s) 121, 122, 123, 124, 125, 126, which may be stored on a computing device 401, 402, 403, 404. In further embodiments, an orchestration module 140 may be configured to run a system module 140 on a computing device 401, 402, 403, 404, that the orchestration module 150 may be running on. In further embodiments, an orchestration module 140 may be configured to delete a system module 150, a local dataset 120, and/or partial local dataset(s) 121, 122, 123, 124, 125, 126, which may be stored on a computing device 401, 402, 403, 404, that the orchestration module 140 may be running on.

The system 100 may comprise one or more system modules 150. A system module 150 may comprise or function as system logic stored in a memory 310, 410, which may be executable by the processor 302, 405, of a server 300 and/or computing device 401, 402, 403, 404. In some embodiments, and in addition to any other functions described herein, a system module 150 may be configured to generate a data processing output 112 in response to a data processing request 111 that may be received by the system 100. Generally, a system module 150 may comprise software that may perform software operations on a local dataset 120, and/or partial local dataset(s) 121, 122, 123, 124, 125, 126, and the system 100 may control the ability of the system modules 150 to operate, to exist on a client device 401, 402, 403, 404, and to which computing device(s) 401, 402, 403, 404, a data processing output 112 should be provided to.

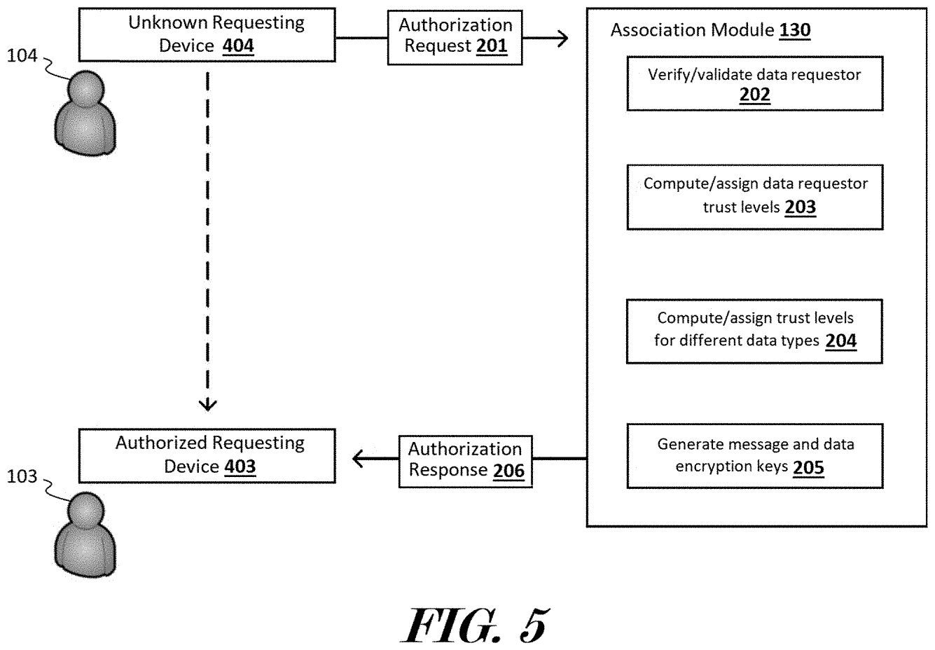

FIG. 5 depicts a schematic diagram of some example functions of an association module 130 which may enable an unknown requesting device 404 and an unknown requesting user 104 to become an authorized requesting device 403 and authorized requesting user 103, respectively. An authorized requesting user 403 may then participate in the movement of data of a local dataset 120 and/or system modules 150 through their authorized requesting device 403. Prior to being granted access data of a local dataset 120 and/or system modules 150, the unknown requesting user 104 must obtain authorization including identify verification and validation, trust level and permission hierarchy, and the associated encryption capabilities. In some embodiments, the unknown requesting user 104 may provide an authorization request 201 via their unknown requesting device 404 to an association module 130. The association module 130 may then verify and validate 202 the unknown requesting user 104, compute and assign trust levels 203 for the unknown requesting user 104, compute and assign trust levels 204 for different data types, and generate, via a key manager engine 132, message and data encryption key 205. After the performance of these functions, the association module 130 may send an authorization response 206 to the requestor so that they may become an authorized requesting device 403 and authorized requesting user 103, respectively.

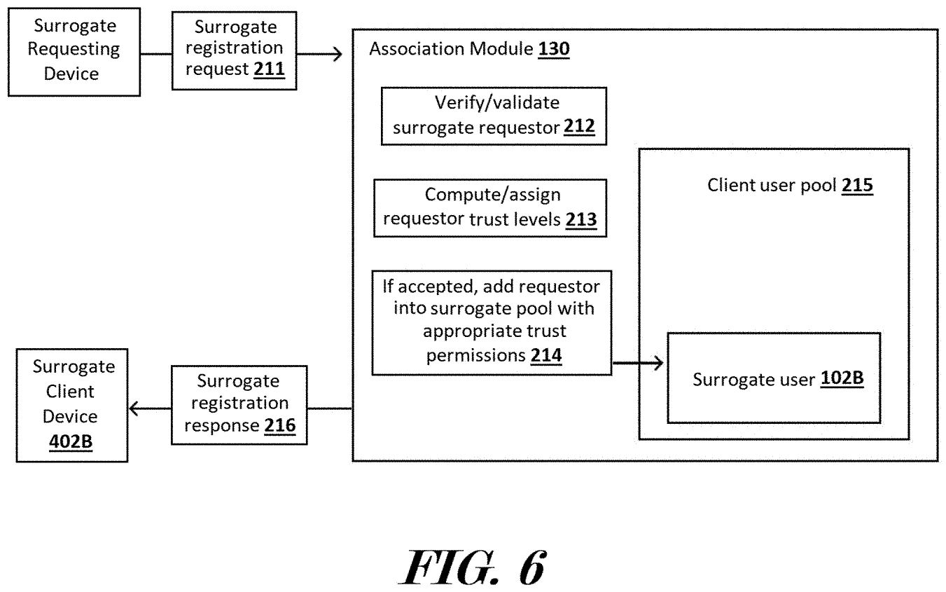

FIG. 6 illustrates a schematic diagram of some example functions of an association module 130 which may enable a client device 402 and client user 102 to become a surrogate client device 402B and surrogate user 102B, respectively. In this manner, an association module 130 may enable the registration of relationships between client users 102 and their respective client device(s) 402, authorized requesting users 103 and their respective authorized requesting device(s) 403, data owners 101 and their respective data owner device(s) 401, and cloud networks to the permissioned cluster or pool of client devices 402 to access data of a local dataset 120 and/or system modules 150 stored within a network 105 of client devices 401, 402, 402A, 402B, 403, 404. A client user 102 may provide a surrogate registration request 211 to an association module 130 via their client device 402. The association module 130 may verify and validate the surrogate requestor 212 and compute and assign surrogate requestor trust levels 213. If accepted, the association module 130 may add the requestor into client device pool with appropriate trust permissions 214. Once the requestor is added to the client device pool 215 as a surrogate user 102B, the surrogate client device 402B of the surrogate user 102B may be granted access to data of a local dataset 120 and/or system module(s) 150 depending on their trust permissions and the association module 130 may provide a surrogate registration response 216 to the surrogate client device 402B of the now surrogate user 102B.

In preferred embodiments, the system 100 may assign trust capabilities to surrogate users 102B and their surrogate client devices 402B based on the relationship of the data owner 101 and surrogate user 102B and the type of data. For example, data trust capabilities that may be assigned to surrogate users 102B and their surrogate client devices 402 may include: transient unencrypted data trust capability; external data module container trust capability; encrypted data storage trust capability: and encrypted data portion storage trust capability. Transient unencrypted data trust capability may allow a surrogate client device 402B to keep unencrypted data of a local dataset 120 in its memory for a short amount of time so that the unencrypted data cannot be persisted in its memory. External data module container trust capability may allow a surrogate client device 402B to install system modules 150 and pass unencrypted data for processing. Encrypted data storage trust capability may allow a surrogate client device 402B to keep encrypted local dataset 120 and/or encrypted partial local datasets 121, 122, 123, 124, 125, 126, in memory or on disk. Encrypted data portion storage trust capability may allow a surrogate client device 402B to keep one or more encrypted partial local datasets 121, 122, 123, 124, 125, 126, in memory or on disk.

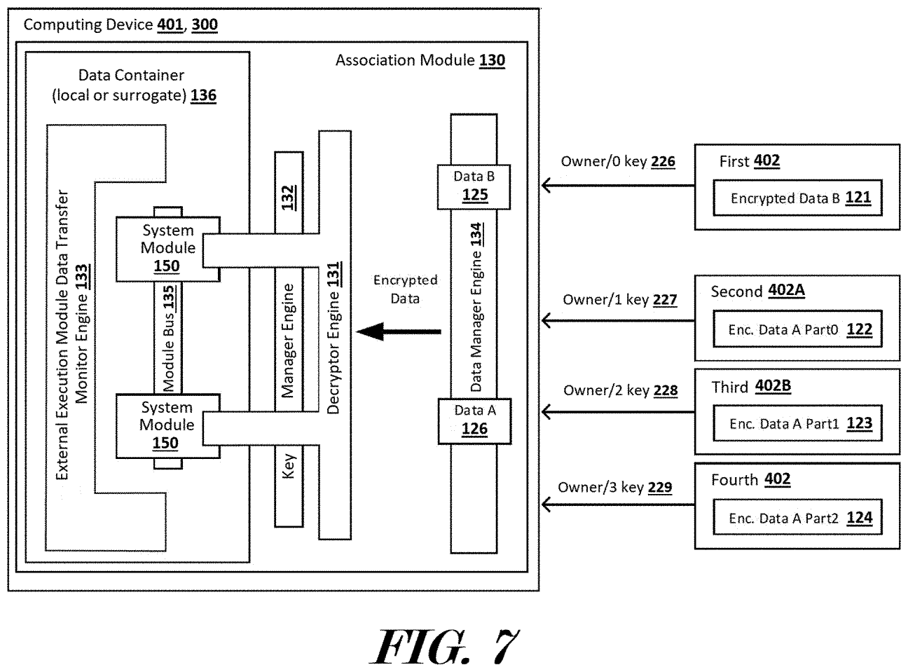

FIG. 7 illustrates a schematic diagram of an example embodiment of how the system 100 may enable accessing various encrypted data stored in a distributed network of client devices 401, 402, 402A, 402B, 403, 404. Preferably, the data of a local dataset 120 may be divided or otherwise partitioned by an association module 130 into a number of optionally encrypted partial local datasets 121, 122, 123, 124, 125, 126, that may be stored on a number of client devices 402, such as one or more owner client devices 402A and/or surrogate client devices 402B, and each client device 402 may comprise a key 226, 227, 228, 229, for their respective partial local datasets 121, 122, 123, 124. Each permissioned client device 402 that has the relevant data, in whole or in part, may be queried for their partial local datasets 121, 122, 123, 124, which are then collected by a data manager engine 134 and subsequently decrypted by a decryptor engine 131 and key manager engine 132. The decrypted data is then available for processing by system module(s) 150 via a module bus 135 process. Preferably, data cannot be decrypted without the approval of the data owner 101. Any decrypted data is subsequently destroyed within a defined time period that may be selectable by the data owner 101. In preferred embodiments, decrypted data of a local dataset 120 is only permitted for trusted, permissioned client devices 402, data owner devices 401, and/or trusted cloud networks. In this example, a first client device 402 may be storing a first partial local dataset 121 while a second client device 402 that is an owner client device 402A, third client device 402 that is a surrogate client device 402B, and fourth client device 402 may be storing a second, third, and fourth partial local dataset 122, 123, 124, respectively. The first partial local dataset 121 may be collected into a fifth partial local dataset 125 and the second, third, and fourth partial local dataset 122, 123, 124, may be collected to form a sixth partial local dataset 126 by the data manager engine 134.

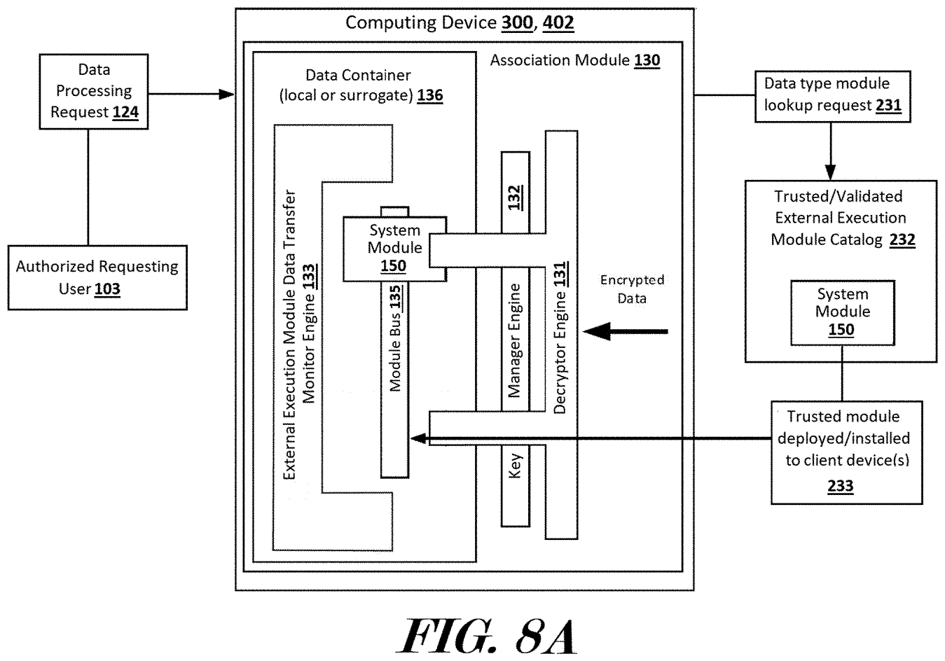

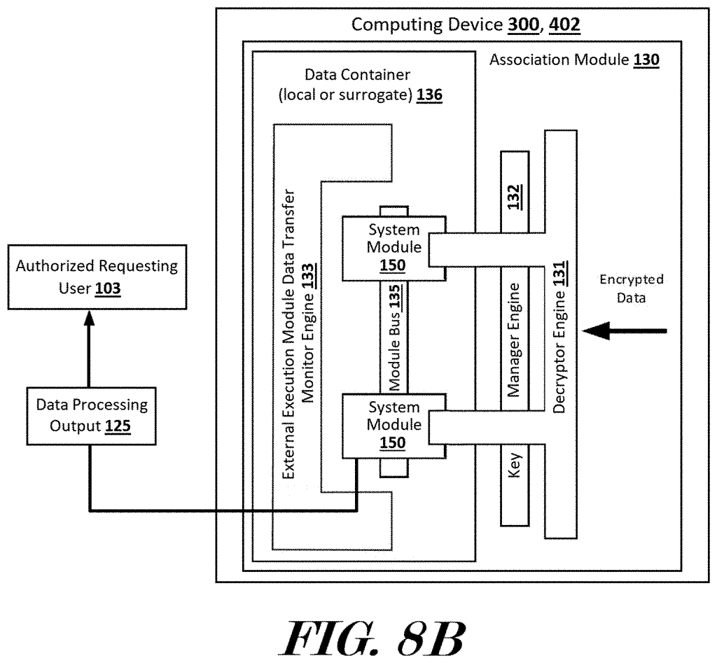

FIGS. 8A and 8B illustrates a schematic diagram of an example embodiment of how the system 100, via one or more computing devices, such as a server 300, client device(s) 402, etc., may enable a known entity or authorized requesting user 103 to request data via a data processing request 111 from their authorized requesting device 403 in a distributed network of devices, in which a system module 150 for processing the data processing request 111 is identified in a module catalogue 232 of approved system modules 150. If the requested data type of the data processing request 111 is unknown, a data type module lookup request 231 is generated for a lookup into a trusted and validated external execution module catalog 232 containing verified system modules 150. Preferably, the matching system module(s) 150 may then be deployed to the client device 402, or trusted group of client devices 402 based on a permissioned hierarchy. If validated, the trusted system 150 module is deployed to the client device(s) 402 containing the data for decryption and processing as necessary as shown in FIG. 8A. The resulting data is then redistributed to the authorized requesting device 403 of the authorized requesting user 102 via a data processing output 112 that is generated by the deployed system module 150.

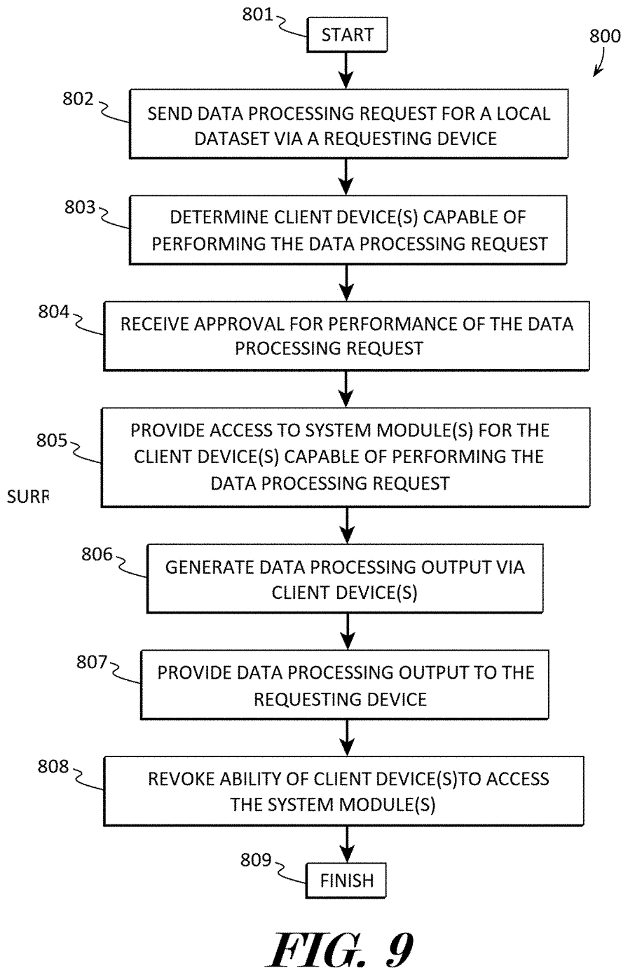

FIG. 9 shows a block diagram of an example of a computer-implemented method for installing, authorizing, and running approved software modules in a network that includes at least one client device, the network having a local dataset controlled by an owner of the local dataset (“the method”) 800 according to various embodiments described herein. In some embodiments, the method 800 may be used for installing, authorizing, and running approved system modules 150 (software modules, such as .exe, etc.) on a local or an authorized network 105 that has a local dataset 120 controlled by the data owner 101 of the local dataset 120. The system modules 150 are only able to access data of the local dataset 120 permissioned by the data owner 101 and the system modules 150 provide limited output in the form of data processing output 112 after running computation on the data based on what has been allowed by the data owner 101. One or more steps of the method 800 may be performed by one or more association modules 130, orchestration modules 140, and/or system modules 150 which may be executed by a computing device processor, such as a processor 302 (FIG. 2) and/or a processor 405 (FIG. 3).

The method 800 may start 801, and a data processing request 111 for a local dataset 120 may be sent from a requesting user 103, 104, to a first data owner device 401 in step 802. In preferred embodiments, the data processing request 111 may only be sent to the data owner device 401 if the data processing request 111 is from an authorized requesting device 403 of an authorized requesting user 103, as opposed to being from an unknown requesting device 404 of an unknown requesting user 104. The data processing request 111 may be generated via an orchestration module 140 based on input of the requesting user 103, 104, which may include a description of the data of the local dataset 120 to be accessed and what the data processing output 112 will be and for who. In preferred embodiments, a data processing request 11 may include: identification of data to be accessed; what the data processing output 112 will be; and identification of the requesting user as an authorized requesting user 103. An association module 130 may validate and authorize the data processing request 111 to ensure the request 111 is coming from a reputable source (authorized requesting user 103 via their authorized requesting device 403.

In step 803, one or more client devices 402 capable of performing all or portions of the data processing request 111 may be determined by an association module 130. The client devices 402 may include one or more owner client devices 402A and/or surrogate client devices 402B. In some embodiments, the first data owner device 401 may be owned by a data owner 101, and the one or more client devices 402 capable of performing the data processing request 111 may comprise one or more owner client devices 402A which may also be owned by the data owner 101 while being operated by an owner user 102A. For example, a client device 402 may comprise a smartphone or laptop computer (owner client device 402A) owned by a company (data owner 101) but operated by an employee (owner user 102A) of that company. In further embodiments, a client device 402 capable of performing the data processing request 111 may be owned and operated by a surrogate user 102B and step 803 may comprise receiving approval for the performance of the data processing request 111 from the surrogate user 102B via their surrogate client device 402B. For example, an employee (surrogate user 102B) of a company may have purchased their own smartphone or laptop computer (surrogate client device 402B) and the employee (surrogate user 102B) may provide approval or authorization for their smartphone or laptop computer to be a surrogate client device 402B that may be used for the processing of data processing requests 111 received by the data owner 101 for their local dataset 120.

In preferred embodiments, in order for a client device 402 to be determined to be capable of performing all or portions of the data processing request 111, the client device 402 may be required to be authorized by the data owner 101, such as by the data owner 101 providing input via their data owner device 401 that affirms that the client device 402 is authorized to receive a system module 150 and any data of the local dataset 120 that the system module 150 requires in order to generate a data processing output 112. This enables the data owner 101 to have control over which client devices 402 have access to all or specific portions 121, 122, 123, 124, 125, 126, of the local dataset 120 and which client devices 402 may be used to generate a data processing output 112 for the data processing request 111 received in step 802. In some embodiments, a required processing quantity for data calculations required by a system module 150 in order to generate the data processing output 112 may be computed by an association module 130 and compared to the client devices 402. Preferably, if processing requirements are too high, the data owner 101 can deny, or can “draft” new client devices 402.

In preferred embodiments, each system module 150 may be verified for security computing and its processing will be measured or scored as a required processing quantity for data calculations, and this measurement may include computation (CPU) and data access (I/O) usage requirements for the system module 150. These measurements or scores may be combined with the quantity of data that the system module 150 has access to generate a data processing output 112 in order to determine an estimate of how many processing client devices 402 are required as there may be different numbers of processing client devices 402 depending on the types of client devices 402 that are available.

In some embodiments, each client device 402 that is determined by the association module 130 to be capable of performing the data processing request 111 is required to have access to the local dataset 120 or at least to a portion of the data of the local dataset 120 (a portion of the local dataset 120 being a partial local dataset 121, 122, 123, 124, 125, 126).

In some embodiments, step 803 may comprise comparing, via an association module 130, a processing capability threshold for the data processing request 111 to a processing capability or computing speed of each client device 402 that has access to the data of the data processing request 111. A processing capability threshold may describe the minimum computation (CPU) processing capability that a computing device, such as a client device 402, is required to be capable of in order for the computing device to generate a data processing output 112. A processing capability of a computing device, such as a client device 402, may describe the processing or computation (CPU) capability of the computing device.

In some embodiments, step 803 may comprise the association module 130 measuring a computation requirement of the system module 150, a data access requirement of the system module 150, and a quantity of data that the system module 150 is required to access in order to determine an estimate of how many client devices 402 are required for the performance of the data processing request 111. A computation requirement of the system module 150 may describe a processing capability or computing speed that a client device 402 is required to achieve in order to run the system module 150. A data access requirement of the system module 150 may describe the type of data that the system module 150 requires in order to generate a data processing output 112 for a data processing request 111. A quantity of data that the system module 150 is required to access may describe how much data must be communicated across the network 105 for the system module 150 to generate a data processing output 112 for a data processing request 111. For example, the association module 130 may measure a computation requirement of the system module 150, a data access requirement of the system module 150, and a quantity of data that the system module 150, which the association module 130 may compare to the processing capability and data access (I/O) capabilities of the client devices 402. If the measurement scores above estimate that the processing time and data access from one client device 402 will either a) take too long and/or b) consume too much of the processing power of the client device 402 (meaning that the job will essentially make the device 402 unusable for other tasks), then the workload can be split up and distributed between two or more client devices 402. If the data owner 101 does not have connections to enough client devices 402 to satisfy a) and b) then a draft can be initiated to try to “find” more client devices 402, or the data owner 101 can deny the data processing request 111.

In step 804, approval for the performance of the data processing request 111 by the one or more client devices 402 determined in step 803 may be received from the first data owner device 401. In preferred embodiments, performance of the data processing request 111 may be required to be authorized by the data owner 101, such as by the data owner 101 providing input via their data owner device 401 that affirms that the data owner 101 consents to the performance of data processing request 111. This enables the data owner 101 to have control over whether or not the data processing request 111 is performed by the system 100.

In step 805 access to one or more system modules 150 required in order to generate a data processing output 112 for the data processing request 111 may be provided by an association module 130 to the one or more client devices 402 determined in step 803. In preferred embodiments, any system module 150 that is provided to a client device 402 may be authorized by the system 100 to ensure the system module 150 only performs functions that it claims to perform to prevent unauthorized access to the data of the local dataset 120. In further preferred embodiments, access to a system module 150 may be provided to a client device 402 by allowing the system module 150 to be downloaded to the client device 402 so that a copy of the system module 150 may be stored on the client device 402. In further embodiments, access to a system module 150 may be provided to a client device 402 by allowing the client device 402 to access the system module 150 which may be running on another computing device, such as a server 300 or other client device 402, to enable the system module 150 to be run using cloud computing.

In step 806, a data processing output 112 may be generated by the one or more client devices 402. In some embodiments, a data processing output 112 may be generated by one client device 402. In further embodiments, a data processing output 112 may be generated by combining the processing results of two or more client devices 402.

In step 807, the data processing output 112 may be provided to the requesting device. In preferred embodiments, the data processing output 112 may be provided to the requesting device that is an authorized requesting device 403 that is operated by an authorized requesting user 103. Optionally, the data processing output 112 may be provided directly from the one or more client devices 402 or the processing output from the one or more client devices 402 may be provided to an association module 130 to be collated, assembled, or otherwise combined into the data processing output 112 that may then be provided to the authorized requesting device 403.

In step 808, the ability of the client device(s) 402 to access the system module 150 may be revoked. In preferred embodiments, the ability of the client device(s) 402 to access the system module 150 may be revoked by an orchestration module 140 running on the client device(s) 402 based on input received from the data owner 101 via an orchestration module 140 running on their data owner device 401. In further preferred embodiments, the ability of the client device(s) 402 to access the system module 150 may be revoked by the system module 150 being deleted from the client device(s) 402 by an orchestration module 140 running on the client device(s) 402. In further embodiments, the ability of the client device(s) 402 to access the system module 150 may be revoked by the system module 150 being prevented from being opened or run on the client device(s) 402 by an orchestration module 140.

Preferably, as part of the system module 150 functioning at module startup and shutdown (before and after execution), the system module 150 will be required to check with the system 100, such as by checking with an orchestration module 140 running on the client device 402 that the system module 150 is running on, and the system module 150 and/or orchestration module 140 will be required to follow commands, such as uninstall. At system module 150 startup, the system module 150 and/or orchestration module 140 running on the client device 402 that the system module 150 is running on may check with an association module 130 which may define if the system module 150 is allowed to execute. In preferred embodiments, an orchestration module 140 that is running on the client device 402 that the system module 150 is running on may be the only way that the system module 150 can be started, so the uninstall, enable/disable may not be left to the system module 150 but may be controlled by the system software of the orchestration module 140.

After step 808, the method 800 may finish 809.

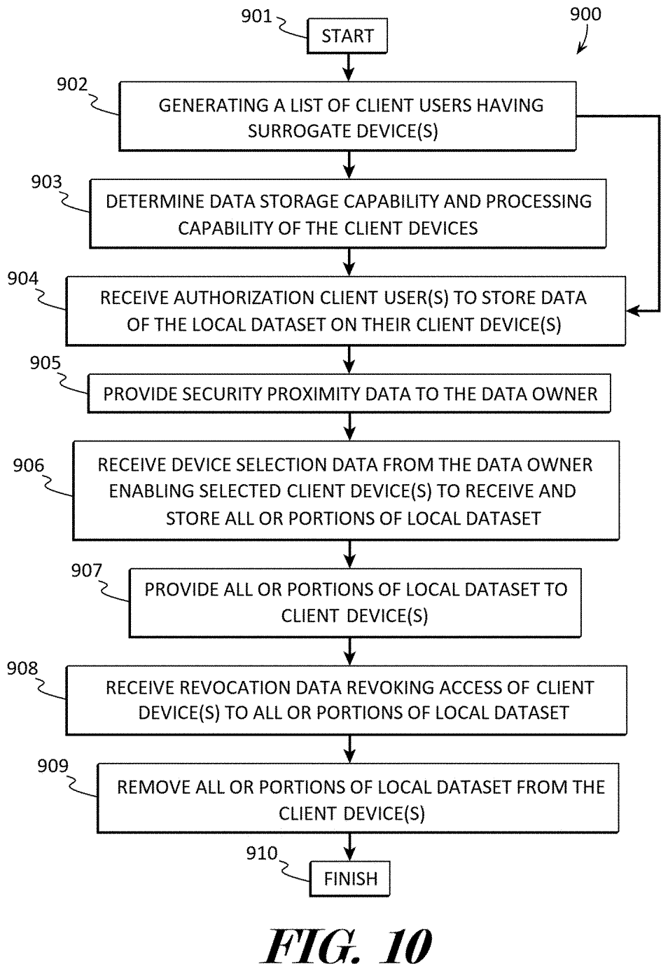

FIG. 10 shows a block diagram of an example of a computer-implemented method for controlling the distributing and storing of data of a local dataset of a data owner on one or more client devices (“the method”) 900 according to various embodiments described herein. In some embodiments, the method 800 may be used for: distributing and storing a local dataset 120 and/or portions of the local data set (partial local datasets 121, 122, 123, 124, 125, 126) on one or more client devices 402; granting permissions for the client devices 402 to exchange data with the data owner device 401 and each other; and controlling access for system module(s) 150 running on the client devices 402 to access the local dataset 120 and/or portions of the local data set (partial local datasets 121, 122, 123, 124, 125, 126). One or more steps of the method 900 may be performed by one or more association modules 130, orchestration modules 140, and/or system modules 150 which may be executed by a computing device processor, such as a processor 302 (FIG. 2) and/or a processor 405 (FIG. 3).

The method 900 may start 901 and a list of client users 102 and their one or more client devices 402 may be generated by the system 100 in step 902. The client users 102 may include one or more owner users 102A and their owner client devices 402A and/or one or more surrogate users 102B and their surrogate client devices 402B. In some embodiments, a list of client users 102 and client devices 402 may be generated by an orchestration module 140 running on the data owner device 401 of the data owner 101 based on input and selections of the data owner 101. For example, a data owner 101 may create a list of potential client users 102, e.g., using contact lists, employee lists, etc., and the client devices 402 of each client user 102 may be queried from the client user 102 via an orchestration module 140 running on the client device(s) 402 of the client users 102 and the list of client users 102 and their client devices 402 may be displayed to the data owner 101 on their data owner device 401.

In some embodiments, a client user 102 may share one or more other client users 102 to the data owner 101, and these shared client users 102 may be added to the list of client users 102 and their one or more client devices 402 that may be generated by the system 100 in step 902.

In some embodiments, the method 900 may include the optional step 903 of determining a data storage capability and a processing capability of the one or more client devices 402 of the client users 102 on the list of client users of step 902.

In some embodiments, an association module 130 and/or an orchestration module 140 may determine a processing capability threshold that the client devices 402 must each at least meet and more preferably exceed in order to be eligible for being selected in step 906. Preferably, an association module 130 and/or an orchestration module 140 may determine a processing capability or computing speed of each client device 402. A processing capability threshold may describe the minimum computation (CPU) processing capability that a computing device, such as a client device 402, is required to be capable of in order for the computing device to provide useful data transfer with the other elements of the system 100. A processing capability of a computing device, such as a client device 402, may describe the processing or computation (CPU) capability of the computing device.

In some embodiments, an association module 130 and/or an orchestration module 140 may determine a data storage capability threshold that the client devices 402 must each at least meet and more preferably exceed in order to be eligible for being selected in step 906. Preferably, an association module 130 and/or an orchestration module 140 may determine a data storage capability or free/usable data storage space of each client device 402. A data storage capability threshold may describe the minimum free/usable data storage space that a computing device, such as a client device 402, is required to be capable of in order for the computing device to store all of the local dataset 120 or to store one or more portions of the local data set (partial local datasets 121, 122, 123, 124, 125, 126). A data storage capability of a computing device, such as a client device 402, may describe the free/usable data storage space of the computing device.

In step 904, authorization may be received from one or more client users 102 to store data of the local dataset 120 on one or more of their client devices 402. Optionally, step 904 may occur before step 902, such as by the authorization being received when the client users 102 enroll in the system 100. Optionally, step 904 may occur during or after step 902, such as by the client users 102 being queried for authorization during or after creation of the list in step 902. In some embodiments, a request for authorization may be provided to the client user(s) 102 via one or more of their client devices 402 and authorization may be received by the system 100 by the client user(s) 102 providing input affirming their authorization via their client device 402. In further embodiments, a request for authorization to potential client users may be provided to the person/organization that is a potential client user 102, but the system 100 may not know which computing devices the potential client users 102 will approve to be a client device 402 of the system 100.

In step 905, security proximity data may be provided to the data owner 101 via their data owner device 401 in which the security proximity data describes how secure the client devices 402 are in relation to the data owner 101. Client users 102 and their client devices 402 may be periodically assessed for security proximity data which may describe “security proximity” of a client device 402 and categorized based on which data will be allowed to be distributed to and accessed by each client device 402. In some embodiments, client devices 402 may be categorized based on the type of computing device that the client devices 402 are (e.g., a mobile phone may be considered less secure than a stationary desktop computer).

Generally, security proximity data may include proximity score thresholds which may comprise data describing the security proximity of a client device 402 and a security scoring of how secure the connection is between the data owner 101 and the client device 402. This security proximity data may comprise proximity score thresholds which may be based on any combination of: the data owner's 101 personal relationship to the client user 102 of the client device 402; the type of computing device that the client device 402 is (e.g., smartphones may have a weaker or lower score than a personal computer because of their mobility as a stationary personal computer is less likely to be lost or stolen than a smartphone is); the physical distance between the client device 402 and the data owner device 401 and/or other client devices 402 on the list of step 902; the logical network distance between the client device 402 and the data owner device 401 and/or other client devices 402 on the list of step 902 (e.g., more secure if the client device 402 is on the same network); and if the client device 402 is drafted because it is a client device 402 of another client device 402 (transitive) then the total score may to account for both the score for the data owner 101 and client device 402 and the score for the client device 402 to the secondary client device 402. In preferred embodiments, the security proximity data may contain data describing that one of the client devices 402 has previously been able to receive all of the local dataset 120 and/or one or more portions of a local data set (partial local datasets 121, 122, 123, 124, 125, 126). For example, if a client user 102 and their client device 402 has already been selected by the data owner 101 in the past, then the security proximity data may include this data.

In some embodiments, data of a local data set 120 may be categorized into data categories which may be assigned a minimum security proximity score which may be visualized as concentric circles with the data owner devices 401 of the data owner 101 at the center. The inner circles are the most secure and require the strongest proximity score. As an example, a strongest score may be 0 representing “self” of the data owner device 401. Individual data sets may be assigned a minimum security strength or the data can be categorized. The categorization may be based on access levels such as low-med-high (the same as full, partial, very limited) or may be based on data contents for an individual: e.g., personal, public, financial. In the case of an organization, it may be based on business group or function, such as legal, human resources, accounting, marketing. If using data content categories, the categories preferably will need to be assigned a minimum security proximity requirement.

In some embodiments, a client user 102 may share one or more other client users 102 to the data owner 101, and these shared client users 102 may be added to the list of client users 102 (similar to a surrogate level or surrogate hop) and their one or more client devices 402 that may be generated by the system 100 in step 902, and the security proximity score for each shared client users 102 may be decreased so that there may be a cost to the security proximity score with each hop.

In step 906, device selection data may be received from the data owner 101, via their data owner device 401, enabling client device(s) 402 selected by the data owner 101 to receive and store all or portions of local dataset 120. Device selection data may be received by an orchestration module 140 running on the data owner device 401 that may receive the selection input from the data owner 101. Generally, device selection data may comprise one or more client devices 402 that the data owner 101 consents to receive and store all of the local dataset 120 and/or to receive and store one or more portions of the local data set (partial local datasets 121, 122, 123, 124, 125, 126). For example, a manufacturing company, with a company executive acting as the data owner 101, could designate only company owned client devices 402 (owner client devices 402A), or client devices 402 owned by company employees (surrogate client devices 402B) may be selected in step 906. The data owner 101 executive may provide input that defines that financial data of the company (a first local dataset 120 or partial local dataset 121) needs to reside on company owned client devices 402 (owner client devices 402A)—even if it is encrypted—but could allow company marketing material (a second local dataset or a second partial local dataset 122) to reside on company employee-owned client devices 402 (surrogate client devices 402B). In either case they are defining where the data of the local dataset 120 can go based on the sensitivity of the data and the comfort of the client devices 402/client users 102 that it is going to.

In step 907, all of the local dataset 120 and/or one or more portions of the local data set (partial local datasets 121, 122, 123, 124, 125, 126) may be provided to one or more of the client device(s) 402 described in the device selection data received in step 906. In preferred embodiments, the local dataset 120 and/or one or more portions of the local data set (partial local datasets 121, 122, 123, 124, 125, 126) that may be provided to the one or more of the client device(s) 402 in step 906 may be encrypted. In some embodiments, the data contained in a partial local dataset 121, 122, 123, 124, 125, 126, that is provided to a client device 402 may be selected by the data owner 101 via their data owner device 401 so that the data owner 101 may decide which data of the local dataset 120 goes to which client device(s) 402. In some embodiments, the data contained in a partial local dataset 121, 122, 123, 124, 125, 126, that is provided to a client device 402 may be selected based on the security proximity data of step 905. For example, a client device 402 having a better security score may be selected to receive more sensitive or more important data of the local dataset 120.

In some embodiments, a copy of the local dataset 120 may be provided by an association module 130 to a client device 402 by being downloaded by the client device 402. In further embodiments, a copy of the local dataset 120 may be provided to a client device 402 by being downloaded by the client device 402 from an orchestration module 140 running on another client device 402 that already has a copy of the local dataset 120. In still further embodiments, a copy one or more portions of the local data set (partial local datasets 121, 122, 123, 124, 125, 126) may be provided by an association module 130 to a client device 402 by being downloaded by the client device 402. In yet further embodiments, a copy of one or more portions of the local data set (partial local datasets 121, 122, 123, 124, 125, 126) may be provided to a client device 402 by being downloaded by the client device 402 from an orchestration module 140 running on another client device 402 that already has a copy of the one or more portions of the local data set (partial local datasets 121, 122, 123, 124, 125, 126). In preferred embodiments, only one portion of the local data set (partial local datasets 121, 122, 123, 124, 125, 126) may be provided to each client device 402 in step 902 to provide data security in the case of a client device 402 being compromised because only a part of the local dataset 120 may be distributed to the client device 402. In further preferred embodiments, data slicing/distribution of a local dataset 120 into partial local datasets 121, 122, 123, 124, 125, 126, may be based on the client user 102 (person/organization) and not on the client device 402. In further embodiments, data slicing/distribution of a local dataset 120 into partial local datasets 121, 122, 123, 124, 125, 126, may be based on the client user 102 (person/organization) and/or on the client device 402.

In step 908, revocation data may be received by the system 100 which may contain data that revokes access of one or more client device(s) 402 of step 907 to all or portions of local dataset 120 that are stored on the respective client device(s) 402. In preferred embodiments, revocation data may be received by an orchestration module 140 running on the client device(s) 402 based on input received from the data owner 101 via an orchestration module 140 running on their data owner device 401. In some embodiments, the revocation data may describe a time period (optionally selected by selecting a specific date) selected by the data owner 101, and after the expiration of the time period the step 909 of removing all of the local dataset 120 and/or one or more portions of the local data set (partial local datasets 121, 122, 123, 124, 125, 126) from the client device(s) 402 may be performed.

In step 909, all of the local dataset 120 and/or one or more portions of the local data set (partial local datasets 121, 122, 123, 124, 125, 126) may be removed from the one or more client device(s) 402 of step 908. In preferred embodiments, all of the local dataset 120 and/or one or more portions of the local data set (partial local datasets 121, 122, 123, 124, 125, 126) may be deleted from the client device(s) 402 by an orchestration module 140 running on the client device(s) 402. Preferably, as part of the orchestration module 140 functioning at module startup and shutdown (before and after execution), the orchestration module 140 will be required to check with the system 100, such as by checking with an association module 130, and the orchestration module 140 will be required to follow commands, such as uninstall, delete, etc., thereby allowing the orchestration module 140 to delete all of the local dataset 120 and/or one or more portions of the local data set (partial local datasets 121, 122, 123, 124, 125, 126) stored on the client device 402 that the orchestration module 140 is running on. In further embodiments, the client user 102 may be notified of the revocation via one or more of their client devices 402, and all of the local dataset 120 and/or one or more portions of the local data set (partial local datasets 121, 122, 123, 124, 125, 126) stored on the client device(s) 402 is removed and no future processing and/or data access is allowed by client user 102 and/or their client device(s) 402.

After step 909, the method 900 may finish 910.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for method for installing, authorizing, and running approved software modules in a network that includes at least one client device, the network having a local dataset controlled by an owner of the local dataset, the method comprising the steps of:
sending a data processing request for a local dataset from a requesting user, via a requesting device, to a first data owner device;
determining at least one client device capable of performing the data processing request;
receiving approval for the performance of the data processing request from the data owner device;
providing access to a system module for the at least one client device capable of performing the data processing request;
generating, via the at least one client device, a data processing output;
providing the data processing output to the requesting device; and
revoking the ability of the at least one client device to access the system module.

2. The method of claim 1, wherein the data processing request is only sent to the data owner device if the data processing request is from an authorized requesting device.

3. The method of claim 1, wherein the data processing request includes: identification of data to be accessed; what the data processing output will be; and identification of the requesting user as an authorized requesting user.

4. The method of claim 1, the at least one client device that is determined to be capable of performing the data processing request is required to have access to at least a portion of the data of the local dataset.

5. The method of claim 1, wherein the step of determining the at least one client device capable of performing the data processing request comprises comparing a processing capability threshold for the data processing request to a processing capability of each client device that has access to the data of the data processing request.

6. The method of claim 1, wherein the step of determining at least one client device capable of performing the data processing request comprises measuring a computation requirement of the system module, a data access requirement of the system module, and a quantity of data that the system module is required to access in order to determine an estimate of how many client devices are required for the performance of the data processing request.

7. The method of claim 1, wherein the at least one client device is selected from the group consisting of an owner client device that is owned by the data owner and a surrogate client device that is not owned by the data owner.

8. The method of claim 1, wherein the step of receiving approval for the performance of the data processing request from the first data owner device further comprises receiving approval for the performance of the data processing request from the at least one client device.

9. The method of claim 1, wherein each client device of the at least one client device capable of performing the data processing request is required to be approved by the data owner.

10. The method of claim 1, wherein the step of revoking the ability of the at least one client device to access the system module is performed by an orchestration module running on the at least one client device.

11. A method for controlling the distributing and storing of data of a local dataset of a data owner on one or more client devices, the method comprising the steps of:
generating a list of client users, the list including at least a first client user and a second client user with each client user having one or more client devices;
receiving authorization from the first client user and second client user to store data of the local dataset on one or more of their respective client devices;
providing security proximity data to a data owner device of the data owner, the security proximity data describing how secure the first client device and second client device are in relation to the data owner;
receiving device selection data from the data owner, via the data owner device, the selection data enabling the first client device to receive and store a first partial local dataset and the selection data enabling the second client device to receive and store a second partial local dataset, wherein the first partial local dataset contains a first portion of the data of the local data and the second partial local dataset contains a second portion of the data of the local data
providing the first partial local dataset to the first client device and the second partial local dataset to the second client device;
receiving revocation data from the data owner, via the data owner device, the revocation data revoking access of at least one of the first client device to the first partial local dataset and the second client device to the second partial local dataset; and
removing at least one of the first partial local dataset from the first client device and the second partial local dataset from the second client device.

12. The method of claim 11, further comprising the step of determining a data storage capability and a processing capability of the one or more client devices of the client users on the list of client users.

13. The method of claim 12, wherein the data storage capability of the first client device and the data storage capability of the second client device must each at least meet a data storage capability threshold

14. The method of claim 12, wherein the processing capability of the first client device and the processing capability of the second client device must at least meet a processing capability threshold.

15. The method of claim 11, wherein the revocation data describes a time period selected by the data owner, and after the expiration of the time period the step of removing at least one of the first partial local dataset from the first client device and the second partial local dataset from the second client device is performed.

16. The method of claim 11, wherein the step of removing at least one of the first partial local dataset from the first client device and the second partial local dataset from the second client device is performed by an orchestration module running on the at least one client device.

17. The method of claim 11, wherein the security proximity data is based on at least one of: data describing a personal relationship existing between the data owner and each client user, data describing a device type of each client device, data describing physical distance between the data owner device and each client device, and data describing logical network distance between each of the client devices.

18. The method of claim 11, wherein the security proximity data contains data describing that at least one of the first client device and second client device has previously been able to receive a third partial local dataset.

19. The method of claim 11, wherein the data contained in the first partial local dataset and the data contained in the second partial local dataset is selected by the data owner via their data owner device.

20. The method of claim 11, wherein the data contained in the first partial local dataset and the data contained in the second partial local dataset is selected based on the security proximity data.
